(19) United States
(12) Patent Application Publication
(10) Pub. No.: US 2009/0098506 A1
(43) Pub. Date: Apr. 16, 2009

(54) Shower head attachment for mixing liquids use to clean teeth

(75) Inventor: Daniel A. Shaw, Naples, FL (US)

Correspondence Address: Allen D. Brufsky;ALLEN D. BRUFSKY, P.A., 475 Galleon Drive, Naples, FL, 34102, US

(73) Assignee: HEALTH AND HYGIENE INC.

(21) Appl. No.: 11/900,763

(22) Filed: Oct. 15, 2007

(51) Int. Cl. A61C 3/00

(52) U.S. Cl. 433/88; 137/597

(57) ABSTRACT

A valve for adjusting the flow of water through an oral irrigation device is connected to a shower head by a flexible conduit. The valve is located on a handle connected to a water-dispensing pick for cleaning teeth and gums. Mixing apparatus is provided for injecting a secondary fluid, such as a mouthwash, into the flexible conduit upstream from the pick in a direct stream from the shower head.

### BACKGROUND OF THE INVENTION

1. Field of the Invention

This invention relates to a dental hygiene device, and more particularly to a syringe for delivering a stream of water for cleaning the teeth and gums of a user while showering in combination with an accessory designed to deliver a mixture of the water and another liquid such as a mouthwash dispensed into the water stream.

2. Description of Prior Art

Numerous methods and apparatus have been suggested for cleaning the teeth and gums by using a jet stream of water.

One widely accepted system involves the use of a pulsating jet of water fed to a hand held syringe by an electrically driven pump placed beside a bathroom sink. This system requires a relatively expensive electrically driven pumping mechanism and the use of space adjacent the sink or water basin.

Therefore, it has been suggested that it would be less time consuming, less messy, more convenient, and less expensive to clean one's teeth and gums with a stream of water in a shower stall rather than over a sink. Different forms of apparatus designed to utilize an oral syringe in a shower are illustrated in U.S. Pat. Nos. 4,043,337; 4,265,229; 4,564,005; and 4,793,331, However, each of these systems requires a valve at the shower head to divert and redirect the stream of water through the syringe. For disabled persons in a wheelchair or for short people this is a distinct disadvantage negating their use of the device because they cannot reach the valve. Further, diverting the stream at the shower head requires some sort of pressure-lowering mechanism, so the full stream is diverted from the shower head to the cleaning unit and the shower flow is stopped. So the full stream can be used for teeth or gum cleaning. Nor are these devices readily subject to disassembly to replace worn or inoperable parts, In my copending application Ser. No. 11/238,614 filed Sep. 29, 2005, assigned to the same assignee as this application, I disclose a shower head attachment which overcomes the deficiencies of the prior art.

In my copending patent application, the disclosure of which is incorporated herein by reference, a valve for adjusting the flow of water through the device is located on the handle connected to the water-dispensing pick. Rotation of the valve controls the amount and pressure of water dispensed through the pick in a direct stream from the shower head. The valve and its components are threadedly connected between the pick and handle of the device and can be readily disassembled to replace any worn parts.

Furthermore, many users find it desirable to mix a quantity of another liquid with the water stream, such as a mouthwash, to multi-task the cleaning operation. This invention discloses such a mixing apparatus which can be used with the water dispensing pick.

### SUMMARY OF THE INVENTION

In accordance with the invention, a container of a secondary liquid source, such as a mouthwash, is joined by two check valves provided within a fitting, and a liquid pump, to inject a quantity of the secondary liquid into the water stream upstream of the pick. One of the check valves closes the secondary liquid source, or mouth of a container, upon a predetermined pressure applied to the liquid pump, such as a syringe, enabling the water from the shower head to mix with a predetermined quantity of the secondary liquid previously dispensed into the fitting body from the secondary liquid source or container. The syringe pumps the secondary liquid from the fitting body through the second check valve, which closes, to preclude ‘backwashing” of the mixed liquid from the shower head. The piston of the syringe when pushed forward injects the secondary liquid into the water stream diverted from the shower head via flexible tubing and out to the hand-held pick. Withdrawl of the syringe piston into its cylinder opens the check valve mouth of the container, or secondary liquid source, so a prescribed quantity of the secondary liquid is dispensed into the fitting and then the piston of the syringe is pushed forward to repeat the process.

### BRIEF DESCRIPTION OF THE DRAWINGS

Further objects and advantages of the invention will become more apparent from the following description and claims and from the accompanying drawing wherein:

FIG. 1 is a fragmentary perspective view of a shower head attachment to which the mixing apparatus of the present invention can be attached;

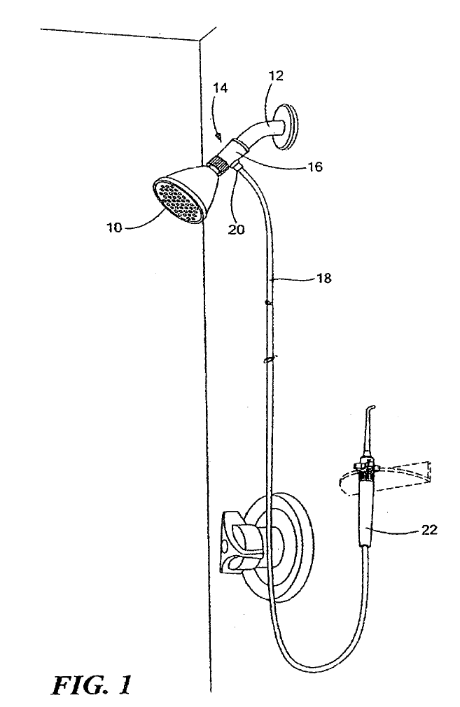

FIG. 2 is a longitudinal cross-sectional view of the shower head attachment of FIG. 1;

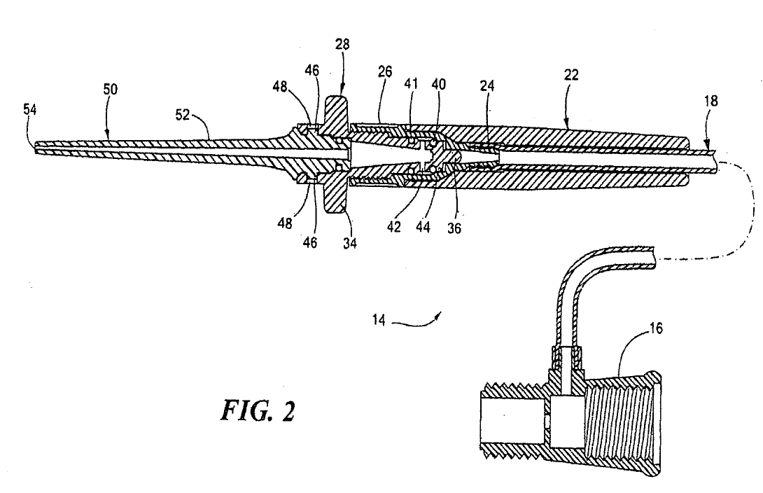

FIG. 3 is an exploded cross-sectional view of the components of the shower head attachment of FIG. 2; and

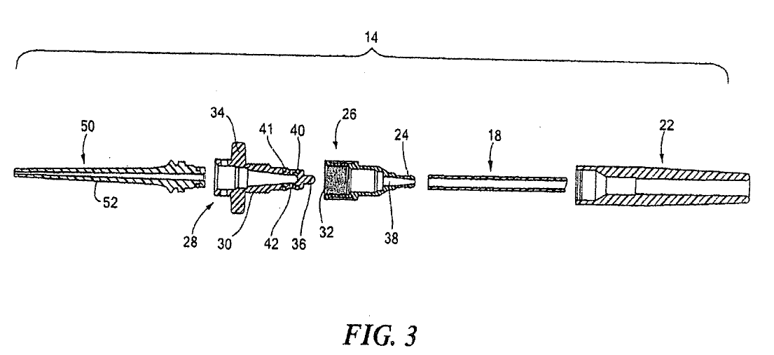

FIG. 4 is a diagrammatic cross-sectional view of the components of the mixing apparatus of the present invention.

### DETAILED DESCRIPTION OF PREFERRED EMBODIMENT

Referring now to my copending application, a shower stall is illustrated which includes a conventional shower head 10, which receives water under pressure from inlet pipe 12. An oral irrigating assembly 14 in accordance with the present invention is interposed between shower head 10 and inlet pipe 12.

The assembly 14 includes a fixture 16 threadedly connected to inlet pipe 12 at one end and the shower head 10 at its opposite end. A flexible conduit 18 is fixed at one end to the fixture 16, which has an opening 20 in communication with the interior of fixture 16. The distal end of the flexible conduit 18 is received within the interior of a handle component 22 and connected over the serrated end 24 of a housing.

The housing 26 threadedly receives a valve 28 having a threaded cylindrical portion 30, received in threaded engagement with a complementary threaded portion 32 within the housing 26. Rotation of threaded portion 30 by means of a handle 34 moves the valve element 28 linearly, relatively out of housing 26, while rotation in an opposite direction moves the valve linearly into the housing.

At the end of valve 28 is a nipple 36 which seats within the bore 38 of the housing and blocks the ingress of water from the conduit 18 through the handle component 22. Rotation of the handle to open the valve, by moving it out of the housing, moves the nipple 36 out of the bore 38. This enables water to enter the housing 26, flow around the nipple 36, past an 0-ring seal 40 and against an 0-ring seal 41 on the valve and through an opening 42 into the interior of the housing. Depending on the distance of travel of the valve relative to the housing 26, the pressure and amount of the water delivered through opening 42 can be varied. To preclude the ingress of water from conduit 18 through valve 28, the valve handle is turned in an opposite direction until the 0-ring seal 40 seats on a housing valve seat 44, effectively shutting the valve and precluding the ingress of water through the housing 26. In the event that nipple 36 becomes worn or truncated, leakage will be contained by O-ring seal 40.

Connected to the valve 28 by a pair of oppositely extending projections 46 received in the openings 48 on the valve 28 is a water pick 50 having an elongated nozzle 52, provided with an opening 54. Water streaming through the valve 28 emanating from the shower head is conducted through the interior of nozzle 52 against the teeth and/or gums of a user to clean the same,

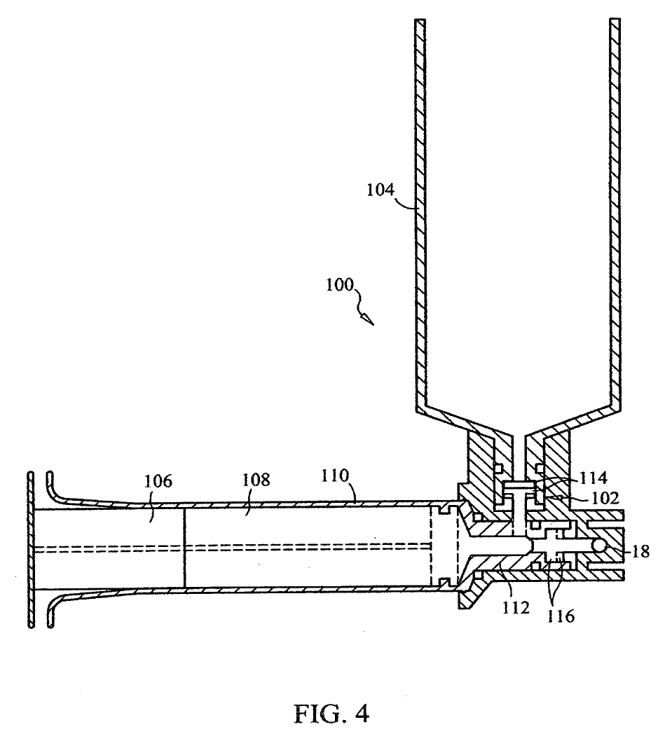

Referring now to FIG. 4 of this application, the apparatus 100 of the present invention is provided with a fitting receiving a container 104 for receiving a quantity of a secondary liquid, such as a mouthwash, to be mixed with the water diverted from the shower head. The mixing apparatus includes a syringe 106 having a hand-operable, linearly moving, plunger or piston 108 in an outer cylinder 110. The fitting 102 receives a portion of the flexible conduit 18 of the shower attachment upstream of the pick assembly. The flexible conduit 18 is opened in a sidewall thereof to provide fluid communication with a chamber 112 in fitting 102.

The container 104 filled with a secondary liquid such as a mouthwash, is joined by two check valves 114, 116 provided within the chamber 112 of fitting 102 connected to the opened sidewall of flexible conduit 18. A liquid pump, such as syringe 106, is used to inject a quantity of the secondary liquid into the water stream flowing through conduit 18 upstream of the pick.

One of the check valves 114 closes the mouth of secondary liquid source container 104, upon a predetermined pressure applied to the piston 108 of the liquid pump syringe, as shown in the full line position of check valve 114, while enabling the water from the shower head to mix with a predetermined quantity of the secondary liquid previously dispensed into the fitting chamber 112 from the secondary liquid source container 104. The syringe piston 108 pumps the secondary liquid from the fitting body chamber 116 through the second check valve 116, which opens to the dotted line position and which closes to its full line position indicated in the FIG. 4, to preclude ‘backwashing” of the mixed liquid from the shower head upon withdrawl of the piston 108 in cylinder 110. The piston 108 of the syringe when pushed forward injects the liquid in chamber 112 through check valve 116 and into the water stream into the conduit 18 between the pick and the shower head. Withdrawl of the syringe piston 108 into its cylinder 110 opens the mouth of the container 104, as the withdrawl relieves the pressure on the check valve 114 so it can open by dropping to its dotted line position as indicated in the FIG. 4, while closing check valve 116 so a prescribed quantity of the secondary liquid is dispensed into the fitting chamber 112 and then the piston 106 of the syringe is pushed forward to repeat the process by injecting the secondary liquid into conduit 18 and opening check valve 116 while closing check valve 114.

1. (canceled)

2. (canceled)

3. (canceled)

4. (canceled)

5. (canceled)

6. (canceled)

7. (canceled)

8. Dental cleaning apparatus for coupling between a water outlet and a showerhead, said apparatus comprising:
a fixture between said water outlet and showerhead for diverting water from said water outlet,
a flexible conduit in fluid communication with said fixture to receive diverted water from said water outlet,
a handle element communicating with an opposite end of said flexible conduit to receive the diverted water,
a valve body provided with a handle portion received within said handle including means for precluding communication of said handle element with said flexible conduit upon movement in one direction, but enabling communication upon movement in an opposite direction,
an oral irrigator coupled to said valve body for transmitting a jet of water to a user of the apparatus upon movement of said valve body enabling communication between said handle element and flexible conduit, and
a mixing apparatus adapted to be placed in fluid communication with said flexible conduit for injecting a secondary liquid into said diverted water,
said mixing apparatus including
a container having an opening for dispensing a secondary fluid housed within said container, and
a fluid pump for moving said secondary fluid dispensed trough said container opening into said flexible conduit,
a fitting having a fluid chamber receiving said container,
said fluid pump and said flexible conduit being in fluid communication,
a first check valve disposed in said fitting between said container and chamber,
a second check valve disposed between said fluid pump in said chamber and said flexible conduit,
whereupon pressure imparted to any fluid in said chamber will close the first check valve and communication between said fining chamber and container, while opening the second check valve between said fitting chamber and flexible conduit enabling fluid in said chamber to be injected into said flexible conduit,
said fluid pump including
means for relieving the pressure in said chamber to open said first check valve and close said second check valve so an amount of said secondary fluid can be dispensed from said container into said fitting chamber.

9. Dental cleaning apparatus for coupling between a water outlet and a showerhead said apparatus comprising:
a fixture between said water outlet and showerhead for diverting water from said water outlet,
a flexible conduit in fluid communication with said fixture to receive diverted water from said water outlet,
a handle element communicating with an opposite end said flexible conduit to receive the diverted water,
a valve body provided with a handle portion received within said handle including means for precluding communication of said handle element with said flexible conduit,
said means for precluding communication of said handle element with said flexible conduit being operational upon movement in one direction, but enabling communication upon movement in an opposite direction,
an oral irrigator coupled to said valve body for transmitting a jet of water to a user of the apparatus upon movement of said valve body enabling communication between said handle element and flexible conduit, and
a mixing apparatus adapted to be placed in fluid communication with said flexible conduit for injecting a secondary liquid into said diverted water,
said mixing apparatus including
a container having an opening for dispensing a secondary fluid housed within said container,
a fluid pump for moving said secondary fluid dispensed through said container opening into said flexible conduit,
said fluid pump being a syringe provided with a linearly slidable, retractable piston in a cylinder,
a fitting having a fluid chamber receiving said container, piston and said flexible conduit in fluid communication, and
a first check valve disposed in said fitting between said container and chamber,
a second check valve disposed between said piston in said chamber and said flexible conduit,
whereupon pressure imparted to any fluid in said chamber Will close the first check valve and communication between said fitting chamber and container, while opening the second check valve between said fitting chamber and flexible conduit enabling fluid in said chamber to be injected into said flexible conduit by said piston.,
said piston upon withdrawl from said chamber will relieve the pressure in said chamber to open said first check valve and close said second check valve so an amount of said secondary fluid can be dispensed from said container into said fitting chamber.
